(19) United States
(12) Patent Application Publication
(10) Pub. No.: US 2026/0274145 A1
(43) Pub. Date: Sep. 17, 2026

(54) Adjustable Tension Wheel Chock Assembly

(71) Applicant: William J. Richter, Meridian, ID (US)

(72) Inventor: William J. Richter, Meridian, ID (US)

(21) Appl. No.: 19/078,361

(22) Filed: Mar. 13, 2025

(51) Int. Cl. B60P 3/077

(52) U.S. Cl. CPC B60P 3/077

(57) ABSTRACT

A vehicle wheel securing device comprises a pair of outwardly facing wheel chocks connected by a tensioner assembly. The assembly includes a tensioner adjuster with oppositely threaded portions and chock adjustors fixedly coupled to respective wheel chocks. Rotation of the tensioner adjuster in one direction simultaneously moves both chocks outwardly against vehicle wheels, preventing both forward and rearward movement during transport. Preferably, the chocks feature cambered surfaces conforming to wheel profiles and textured surfaces for enhanced grip. The device may include a locking mechanism to prevent unauthorized loosening and ergonomic features on the handle section for improved torque application. This unified system eliminates vehicle movement during transit, overcoming limitations of conventional single wheel chocks.

### FIELD OF THE DISCLOSURE

The present invention relates to vehicle securement devices, specifically to wheel chocking systems for preventing unwanted movement of recreational vehicles, all-terrain vehicles (ATVs), side-by-sides, and other wheeled vehicles during transport or storage. More particularly, it relates to adjustable tension-based wheel chock assemblies that simultaneously engage multiple wheels to eliminate forward and backward movement.

### BACKGROUND OF THE INVENTION

The transportation of recreational vehicles such as ATVs, side-by-sides, and other utility vehicles has become increasingly common as outdoor recreational activities have gained popularity. These vehicles represent significant investments for their owners and require secure transportation methods to prevent damage during transit. One of the primary concerns during transport is unwanted movement of the vehicle, which can lead to damage to the transported vehicle, the transport trailer, or in worst cases, accidents on roadways.

Traditional approaches to securing wheeled vehicles during transportation have relied on several methods, each with notable limitations. Tie-down straps have been widely used, but they can lose tension during transit due to vehicle suspension movement and vibration. Additionally, straps can cause damage to vehicle components if improperly positioned or overtightened. Single wheel chocks represent the most common approach and have been in use for decades. These simple devices, typically wedge-shaped blocks made of rubber, wood, or plastic, are placed against the tires to prevent rolling. The conventional method involves positioning one chock in front of a tire and another behind it to prevent both forward and backward movement. While simple and inexpensive, this approach has significant disadvantages.

The fundamental problem with traditional single wheel chocks is their tendency to shift position during transit. Road vibrations, acceleration, deceleration, and cornering forces can cause these chocks to move away from their initial positions, especially on rough terrain or during extended journeys. Once a chock shifts, it no longer prevents vehicle movement, rendering it ineffective. Furthermore, single chocks often lack sufficient friction against smooth trailer surfaces, particularly in wet or icy conditions. This problem is exacerbated by the weight and power of modern recreational vehicles, which can easily overcome the resistance provided by conventional chocks.

Various attempts have been made to address these limitations. Heavier chocks with rubber bases have improved friction somewhat but still suffer from displacement during transport. Chocks with metal hooks designed to grip the trailer deck provide increased resistance to movement but can damage trailer surfaces and still do not reliably prevent displacement during extended transit. Integrated wheel restraint systems built into trailers represent another approach but lack versatility for different vehicle types and add significant cost to trailer manufacturing. These systems also cannot be easily transferred between different trailers or transport platforms.

Despite the evolution of transportation methods for recreational vehicles, a significant technology gap has persisted in the area of reliable wheel chocking systems. What has been missing is a solution that maintains constant pressure against vehicle wheels throughout transport, resists displacement regardless of road conditions or journey duration, adapts to different vehicle sizes and wheel configurations, operates independently of the trailer design, can be easily deployed and removed by a single operator, and provides visual confirmation of proper engagement. This technology gap has resulted in continued reliance on inadequate securement methods, leading to damaged vehicles, damaged trailers, and safety concerns during transport.

The object of the present invention is to provide a wheel securing system that overcomes the limitations of traditional wheel chocks by creating a unified tension-based assembly that simultaneously secures multiple wheels of a vehicle. The invention aims to eliminate the possibility of wheel chock displacement during transit through an adjustable tensioning mechanism that maintains constant pressure against the secured wheels. Furthermore, the invention seeks to provide an adaptable solution suitable for various vehicle types and sizes, with simple operation that can be performed by a single individual without specialized tools or training. Ultimately, the invention's purpose is to significantly enhance the safety and reliability of recreational vehicle transportation while protecting the substantial investments these vehicles represent.

### SUMMARY OF THE INVENTION

In some aspects, the present invention provides a vehicle wheel securing device comprising a first wheel chock configured to prevent rearward movement of a front wheel of a vehicle and a second wheel chock configured to prevent forward movement of a rear wheel of the vehicle, wherein the first and second wheel chocks are outwardly facing.

Some embodiments describe a tensioner adjuster comprising a handle section and oppositely threaded portions extending from opposing sides of the handle section, which enables simultaneous adjustment of both wheel chocks through a single rotational operation.

Further aspects include a first chock adjustor fixedly coupled to the first wheel chock and threadedly connected to a first oppositely threaded portion of the tensioner adjuster, and a second chock adjustor fixedly coupled to the second wheel chock and threadedly connected to a second oppositely threaded portion of the tensioner adjuster.

In certain aspects, rotation of the tensioner adjuster in a first direction causes the first and second chock adjustors to simultaneously move outwardly, thereby pushing the first and second wheel chocks away from a center point and against the respective wheels of the vehicle.

Moreover, rotation of the tensioner adjuster in a second direction causes the first and second chock adjustors to simultaneously move inwardly, thereby pulling the first and second wheel chocks toward the center point and away from the respective wheels of the vehicle.

Some embodiments feature oppositely threaded portions of the tensioner adjuster comprising male threads, and each of the first and second chock adjustors comprising a groove with female threads configured to engage with the male threads of the tensioner adjuster.

Additional aspects include connection mechanisms wherein the first chock adjustor includes a protrusion configured to be received within a corresponding hole in the first wheel chock, while the second chock adjustor includes a hole configured to receive a corresponding protrusion of the second wheel chock.

In particular embodiments, the first and second wheel chocks each comprise a cambered outer surface configured to conform to a profile of the respective wheels of the vehicle, enhancing the contact area between the wheel chock and the tire.

Yet other aspects describe the first and second wheel chocks each comprising a threaded surface configured to increase friction between the wheel chocks and the respective wheels of the vehicle.

In further implementations, the device includes a locking mechanism configured to prevent unauthorized rotation of the tensioner adjuster, wherein the locking mechanism comprises at least one of: a lockable pin configured to engage with the tensioner adjuster, a keyed lock, a combination lock, or a removable component necessary for rotation.

Other embodiments feature the handle section of the tensioner adjuster comprising ergonomic features configured to improve grip and torque application, the ergonomic features comprising at least one of: textured grip surfaces, finger contours, rubberized coating, or extended lever arms.

Even further aspects provide that the handle section has a diameter larger than the oppositely threaded portions to provide increased leverage for manual rotation.

Some implementations describe a method of securing a wheeled vehicle during transport by positioning the first and second wheel chocks adjacent to respective wheels of the vehicle and rotating the tensioner adjuster to simultaneously move the wheel chocks against the wheels.

Additional method aspects include activating a locking mechanism after rotating the tensioner adjuster to prevent unauthorized rotation of the tensioner adjuster during transit.

In final aspects, the invention provides for disengagement of the wheel chocks by rotating the tensioner adjuster in a direction opposite to the engagement direction, thereby simultaneously retracting both wheel chocks and facilitating quick and easy removal of the securing device.

### BRIEF DESCRIPTION OF THE FIGURES

The accompanying drawings, which are incorporated in and constitute a part of this specification, illustrate embodiments of the invention and, together with the description, serve to explain the principles of the invention. The drawings are not necessarily to scale, emphasis instead being placed upon illustrating the principles of the invention. In the drawings:

FIG. 1 is an isometric view of the wheel securing device showing the complete assembly.

FIG. 2 is a side view of the wheel securing device displaying the profile relationship between components.

FIG. 3 is a top plan view of the wheel securing device illustrating the linear alignment of components.

FIG. 4 is an isometric view of the wheel securing device in a partially disassembled aspect showing the tensioner adjuster partially disconnected.

FIG. 5 is an isolated view of the tensioner adjuster highlighting the first and second threaded portions.

FIG. 6 is an isolated view of the chock adjustors featuring the connector for the wheel chock.

FIG. 7 is a view of the wheel securing device with all components separated.

FIG. 8 is a completely disassembled view of the wheel securing device showing all components and connection points in detail.

FIG. 9 shows the wheel securing devices in use securing vehicles on a trailer.

FIG. 10 presents a top-down view of wheel securing devices installed on a trailer.

### DETAILED DESCRIPTION OF PREFERRED EMBODIMENTS

The following description of preferred embodiments may refer to the accompanying drawings, which may illustrate specific embodiments of the vehicle wheel securing device for preventing unwanted movement during transport. Other embodiments having different structures and operations may not depart from the scope of the present invention. Like reference numbers may be used in the drawings and the following description to refer to the same or similar components.

As used herein, the terms “comprising,” “including,” “containing,” “characterized by,” and grammatical equivalents thereof may be inclusive or open-ended and may not exclude additional, unrecited elements or method steps, unless otherwise stated. Other than in the operating examples, or where otherwise indicated, all numbers expressing measurements, mechanical properties, dimensions, angles, tension specifications, and material properties used in the specification and claims may be understood as being modified in all instances by the term “about,” meaning within a reasonable range of the indicated value. The terms “a” and “an” may refer to one or more of the elements described, whereas the term “plurality” may refer to two or more of the elements described, unless the context clearly indicates otherwise.

The wheel chock assembly for vehicle securement described herein may provide novel solutions for enhancing recreational vehicle transportation safety while maintaining ease of use and adaptability. The invention may incorporate oppositely threaded tensioning mechanisms, integrated locking systems, and versatile chock designs, enabling enhanced vehicle stability during transport while preventing unwanted movement. The following detailed description, along with the accompanying drawings, may provide a comprehensive understanding of the various embodiments and aspects of the invention.

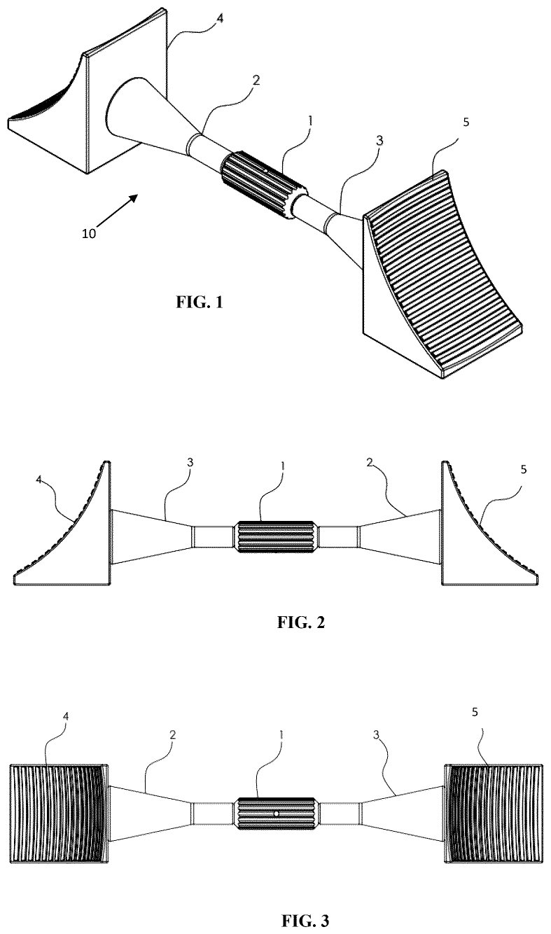

Firstly, FIG. 1 illustrates an isometric view of a wheel securing device 10 according to one aspect of the present invention. The wheel securing device 10 comprises a comprehensive assembly designed to prevent unwanted movement of a vehicle during transport by simultaneously securing multiple wheels.

In a preferred embodiment, the wheel securing device 10 includes a tensioner adjuster 1 positioned centrally within the assembly. The tensioner adjuster 1 features a handle section with grippable surfaces and oppositely threaded portions extending from opposing sides of the handle section. These oppositely threaded portions enable the simultaneous adjustment of connected components when the tensioner adjuster 1 is rotated.

With reference to the illustrated embodiment, a first chock adjustor 2 is threadedly connected to one side of the tensioner adjuster 1. The first chock adjustor 2 comprises an elongated rod with internal threading configured to engage with the corresponding threaded portion of the tensioner adjuster 1. The first chock adjustor 2 terminates at its distal end with a connection mechanism that fixedly couples to a first wheel chock 4.

Similarly, in the aspect shown, a second chock adjustor 3 is threadedly connected to the opposite side of the tensioner adjuster 1. The second chock adjustor 3 mirrors the first chock adjustor 2 in function but contains opposite threading to ensure simultaneous movement when the tensioner adjuster 1 is rotated. The second chock adjustor 3 connects at its distal end to a second wheel chock 5.

The embodiment depicted further shows the first wheel chock 4 and second wheel chock 5 as outwardly facing components with contoured surfaces designed to engage with vehicle tires. When properly installed between the wheels of a vehicle, rotation of the tensioner adjuster 1 causes the wheel chocks to move either toward or away from the vehicle wheels, thereby securing or releasing the vehicle as needed.

Referring now to FIG. 2, a side view of the wheel securing device in another aspect is illustrated. In this particular embodiment, the tensioner adjuster 1 is shown in profile, revealing its cylindrical shape with a central portion having a diameter larger than the threaded portions to facilitate manual rotation. The first chock adjustor 2 extends from one side of the tensioner adjuster 1 and terminates at the first wheel chock 4, which displays a wedge-shaped profile designed to conform to the curvature of a vehicle tire. On the opposite side, the second chock adjustor 3 connects the tensioner adjuster 1 to the second wheel chock 5, creating a symmetrical arrangement that ensures balanced force distribution when the device is installed between vehicle wheels.

In a non-limiting embodiment, FIG. 2 further depicts the angular relationship between the chock adjustors and their respective wheel chocks. The side view clearly shows how the wheel chocks 4 and 5 are oriented outwardly from the central axis of the device, positioning them to effectively prevent both forward and rearward movement of the secured wheels. This configuration allows the device to create a stable, triangulated support structure when installed between adjacent wheels of a vehicle.

Turning now to FIG. 3, a top plan view of the wheel securing device in yet another aspect is presented. This perspective clearly illustrates the linear alignment of the components along a central axis. The tensioner adjuster 1 occupies the central position, with the first chock adjustor 2 and second chock adjustor 3 extending in opposite directions. The first wheel chock 4 and second wheel chock 5 are shown at the terminal ends of their respective chock adjustors, revealing their outward-facing orientation.

Moreover, the top view embodiment of FIG. 3 demonstrates the rotational symmetry of the device around its longitudinal axis, highlighting how the oppositely threaded connections between the tensioner adjuster 1 and the chock adjustors 2 and 3 enable simultaneous movement of both wheel chocks when the tensioner adjuster is rotated. This arrangement ensures that a single rotational action can either tighten or loosen the entire assembly, providing efficient operation for the user.

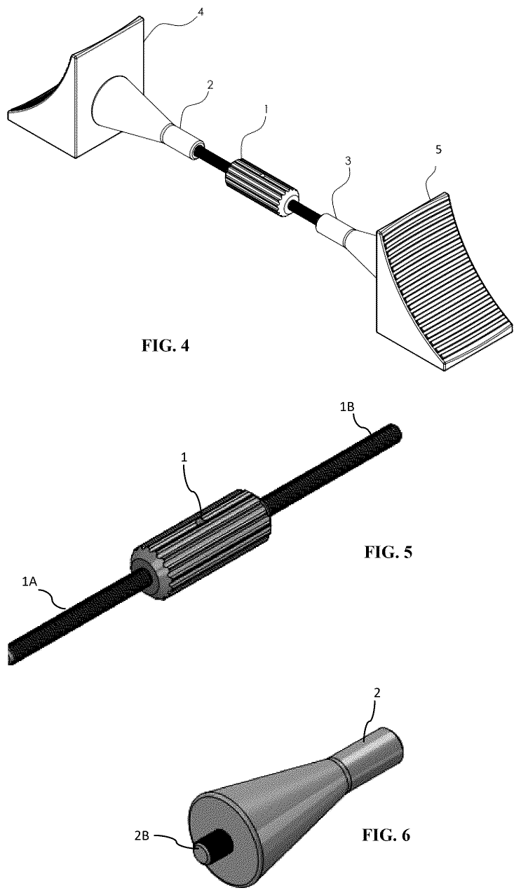

With reference to FIG. 4, an isometric view of the wheel securing device in a partially disassembled aspect is illustrated, specifically showing the tensioner adjuster 1 partially disconnected from a chock adjustor. This exploded view provides clarity regarding the interconnection mechanisms between the key components of the device. The tensioner adjuster 1 is depicted with its threaded portions exposed, revealing the opposite threading orientation on each side that facilitates the simultaneous movement of connected components when rotated.

In one embodiment, FIG. 4 shows the first chock adjustor 2 partially separated from the tensioner adjuster 1, revealing the female threading inside the chock adjustor that corresponds to the male threading on the tensioner adjuster. This threaded connection enables precise adjustment of the distance between wheel chocks. Similarly, the second chock adjustor 3 is shown connected to the opposite side of the tensioner adjuster 1, demonstrating the complete connection in contrast to the partially disassembled section.

The illustrated embodiment further displays the first wheel chock 4 fixedly attached to the distal end of the first chock adjustor 2. This connection may utilize a male-female threaded joint or another secure coupling mechanism that prevents rotation or separation during operation. The second wheel chock 5 is likewise shown attached to the terminal end of the second chock adjustor 3, forming a mirror image of the first wheel chock assembly.

Additionally, this partially disassembled view highlights the modular nature of the wheel securing device, demonstrating how components can be separated for replacement, adjustment, or to accommodate different vehicle configurations. The threaded connections visible in FIG. 4 also illustrate the adjustability feature that allows the device to expand or contract to fit various wheel-to-wheel distances, making it adaptable to different vehicle types and sizes without requiring additional tools or components.

Regarding FIG. 5, an isolated view of the tensioner adjuster is presented to detail its specific structural elements. In this particular embodiment, the tensioner adjuster includes a first threaded portion 1A extending from one side of the central handle section. The first threaded portion 1A features threading in one orientation, such as right-hand threading. Conversely, a second threaded portion 1B extends from the opposite side of the central handle section and features threading in the opposite orientation, such as left-hand threading. This arrangement of oppositely oriented threaded portions ensures that rotation of the tensioner adjuster in either direction causes simultaneous and symmetric movement of both attached chock adjustors, either toward or away from the center depending on the direction of rotation.

With reference to FIG. 6, an isolated view of the chock adjustors is depicted to illustrate their specific features. The figure particularly highlights a connector 2A located at the terminal end of the first chock adjustor. This connector 2A is specifically designed to interface with the wheel chock, providing a secure and non-rotating attachment. In one embodiment, connector 2A may feature male threading that corresponds to female threading within the wheel chock, allowing for a firm connection while still permitting the wheel chock to be detached if necessary for replacement or to accommodate different wheel configurations. The connector design ensures that force applied through the tensioning system is effectively transferred to the wheel chock without slippage or misalignment during use.

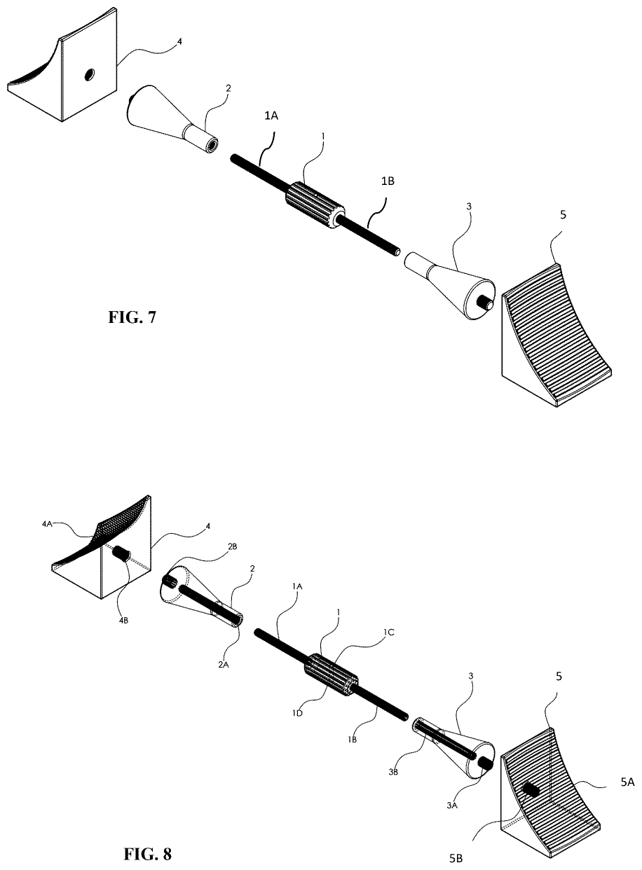

Turning now to FIG. 7, a completely disassembled view of the wheel securing device is presented, displaying all individual components separated from one another. In this comprehensive exploded view, the tensioner adjuster 1 is shown in isolation, revealing the complete threaded portions on both sides that serve as the central adjustment mechanism for the entire assembly. The first chock adjustor 2 and second chock adjustor 3 are displayed separately, clearly illustrating their internal threaded portions that correspond to the threading on the tensioner adjuster. Furthermore, the first wheel chock 4 and second wheel chock 5 are depicted detached from their respective chock adjustors, revealing the coupling interfaces that enable secure attachment during assembly. This disassembled aspect demonstrates the modular design of the wheel securing device, showcasing how each component contributes to the overall functionality while allowing for customization, replacement of individual parts, or adaptation to different vehicle configurations as needed.

Examining FIG. 8, a completely disassembled view of the wheel securing device is illustrated, revealing all components in their individual states along with their specific connection points and functional features. In this detailed exploded view, the tensioner adjuster 1 is displayed with its constituent parts clearly identified, including the first threaded portion 1A and second threaded portion 1B which feature opposite threading directions to enable the simultaneous movement of connected components when the tensioner adjuster is rotated.

Additionally, the first chock adjustor 2 is shown with its connector for threaded portion 2A, which contains internal threading designed to mate precisely with the first threaded portion 1A of the tensioner adjuster. The opposite end of the first chock adjustor features connector 2B, specifically designed to interface with the corresponding connection point on the wheel chock. Similarly, the second chock adjustor 3 is illustrated with its connector for threaded portion 3A containing internal threading with opposite orientation to mate with second threaded portion 1B, and connector for wheel chock 3B at its terminal end.

Furthermore, the first wheel chock 4 is depicted with its threaded friction surface 4A, which provides enhanced grip against the vehicle tire when deployed. The chock adjustor connector 4B is also clearly visible, showing the attachment mechanism that interfaces with connector 2B on the first chock adjustor. In a corresponding manner, the second wheel chock 5 is shown with its threaded friction surface 5A providing similar enhanced grip capabilities, and chock adjustor connector 5B designed to mate securely with connector 3B on the second chock adjustor.

The fully disassembled representation in FIG. 8 demonstrates the symmetrical nature of the device design, with components on each side mirroring one another in function while featuring opposite threading orientations. This configuration ensures balanced operation when the device is assembled and installed between vehicle wheels, with a single rotational action of the tensioner adjuster creating simultaneous and equal adjustment on both sides of the device.

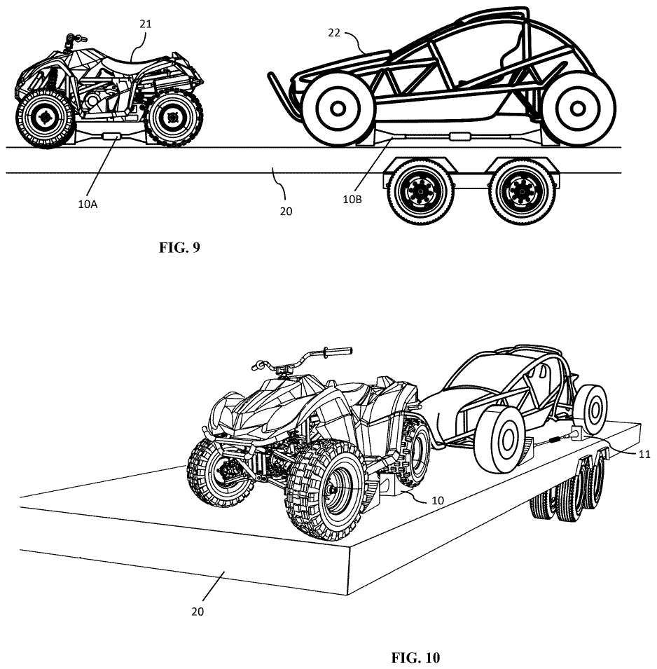

Looking at FIG. 9, a practical implementation of the wheel securing device in an actual use scenario is depicted. In this illustrative embodiment, a trailer 20 is shown loaded with a first vehicle 21 and a second vehicle 22, both securely fastened to prevent movement during transport. The first wheel securing device 11 is installed between adjacent wheels of the first vehicle 21, with the wheel chocks positioned to prevent both forward and rearward movement.

Similarly, the second wheel securing device 10 is shown securing the second vehicle 22 on the trailer 20. This implementation demonstrates how the devices can be positioned between the front and rear wheels of each vehicle, with the tensioner adjusters tightened to create firm pressure against the tire surfaces. The configuration illustrates the practical application of the invention in a common transportation scenario involving recreational vehicles such as ATVs or side-by-sides.

Furthermore, FIG. 9 highlights how multiple wheel securing devices can be used simultaneously on a single trailer to secure multiple vehicles. This application showcases the versatility of the devices in real-world transport situations where preventing vehicle movement is critical for safety during transit. The installation depicted shows how the devices operate independently of the trailer design or tie-down systems, providing an additional layer of security for valuable vehicles.

Directing attention to FIG. 10, a top-down perspective of the wheel securing devices installed on a trailer is presented. In this particular embodiment, the trailer 20 is depicted with multiple vehicles secured for transport using the wheel securing devices. The first wheel securing device 11 is shown installed between adjacent wheels of a vehicle positioned at the front section of the trailer 20, with the tensioner adjuster centered between the wheels and the wheel chocks firmly engaged against the tire surfaces.

Similarly, the second wheel securing device 10 is illustrated securing a vehicle positioned at the rear section of the trailer 20. This overhead view clearly demonstrates the spatial relationship between the securing devices and the trailer structure, showing how they operate independently of the trailer design while complementing other securement methods such as tie-down straps or integrated locking mechanisms.

Moreover, FIG. 10 reveals the positioning strategy for optimal securement, with the devices oriented perpendicular to the direction of travel to maximize their effectiveness in preventing unwanted vehicle movement. This configuration ensures that forces encountered during acceleration, deceleration, and cornering are effectively counteracted by the wheel chocks, maintaining vehicle stability throughout transport regardless of road conditions or journey duration.

### INDUSTRIAL APPLICATION

The vehicle wheel securing device described herein has significant industrial applicability in the transportation sector, particularly for recreational and utility vehicle transport. The device can be manufactured using standard machining and metal fabrication processes, with potential for mass production using injection molding for non-metallic components. Primary markets include recreational vehicle dealers, trailer manufacturers, vehicle rental companies, and individual consumers who transport ATVs, side-by-sides, and similar vehicles. The technology may also find applications in commercial transportation fleets, military vehicle transport, motorsports, agricultural equipment securement, and emergency response vehicle transportation where reliable wheel immobilization is critical for safety and equipment preservation.

What is claimed is:

1. A vehicle wheel securing device comprising:
a first wheel chock configured to prevent rearward movement of a front wheel of a vehicle;
a second wheel chock configured to prevent forward movement of a rear wheel of the vehicle, wherein the first and second wheel chocks are outwardly facing;
a tensioner adjuster comprising a handle section and oppositely threaded portions extending from opposing sides of the handle section;
a first chock adjustor fixedly coupled to the first wheel chock and threadedly connected to a first oppositely threaded portion of the tensioner adjuster; and
a second chock adjustor fixedly coupled to the second wheel chock and threadedly connected to a second oppositely threaded portion of the tensioner adjuster;
wherein rotation of the tensioner adjuster in a first direction causes the first and second chock adjustors to simultaneously move outwardly, thereby pushing the first and second wheel chocks away from a center point and against the respective wheels of the vehicle; and
wherein rotation of the tensioner adjuster in a second direction causes the first and second chock adjustors to simultaneously move inwardly, thereby pulling the first and second wheel chocks toward the center point and away from the respective wheels of the vehicle.

2. The vehicle wheel securing device of claim 1, wherein the oppositely threaded portions of the tensioner adjuster comprise male threads, and wherein each of the first and second chock adjustors comprises a groove with female threads configured to engage with the male threads of the tensioner adjuster.

3. The vehicle wheel securing device of claim 1, wherein the first chock adjustor includes a protrusion configured to be received within a corresponding hole in the first wheel chock.

4. The vehicle wheel securing device of claim 3, wherein the second chock adjustor includes a hole configured to receive a corresponding protrusion of the second wheel chock.

5. The vehicle wheel securing device of claim 1, wherein the first and second wheel chocks each comprise a cambered outer surface configured to conform to a profile of the respective wheels of the vehicle.

6. The vehicle wheel securing device of claim 1, wherein the first and second wheel chocks each comprise a threaded surface configured to increase friction between the wheel chocks and the respective wheels of the vehicle.

7. The vehicle wheel securing device of claim 1, further comprising a locking mechanism configured to prevent unauthorized rotation of the tensioner adjuster, wherein the locking mechanism comprises at least one of: a lockable pin configured to engage with the tensioner adjuster, a keyed lock, a combination lock, or a removable component necessary for rotation.

8. The vehicle wheel securing device of claim 1, wherein the handle section of the tensioner adjuster comprises ergonomic features configured to improve grip and torque application, the ergonomic features comprising at least one of: textured grip surfaces, finger contours, rubberized coating, or extended lever arms.

9. The vehicle wheel securing device of claim 8, wherein the handle section has a diameter larger than the oppositely threaded portions to provide increased leverage for manual rotation.

10. A method of securing a wheeled vehicle during transport, the method comprising:
positioning a first wheel chock adjacent to a first wheel of the vehicle;
positioning a second wheel chock adjacent to a second wheel of the vehicle, wherein the first and second wheel chocks are connected by a tensioner assembly comprising a tensioner adjuster with oppositely threaded portions;
rotating the tensioner adjuster in a first direction to simultaneously move the first and second wheel chocks outwardly away from a center point, thereby urging the first wheel chock against the first wheel to prevent rearward movement of the first wheel and urging the second wheel chock against the second wheel to prevent forward movement of the second wheel.

11. The method of claim 1, wherein the first wheel is a front wheel of the vehicle and the second wheel is a rear wheel of the vehicle.

12. The method of claim 1, further comprising rotating the tensioner adjuster in a second direction opposite to the first direction to simultaneously move the first and second wheel chocks inwardly toward the center point, thereby disengaging the wheel chocks from the respective wheels for removal of the wheel chocks.

13. The method of claim 1, further comprising activating a locking mechanism after rotating the tensioner adjuster to prevent unauthorized rotation of the tensioner adjuster.

14. The method of claim 1, wherein the first and second wheel chocks each comprise a cambered outer surface, and wherein positioning the first and second wheel chocks includes aligning the cambered outer surfaces to conform to a profile of the respective wheels.

15. The method of claim 1, wherein rotating the tensioner adjuster comprises gripping an ergonomic handle section of the tensioner adjuster and applying torque to the handle section.

16. The method of claim 1, wherein the tensioner assembly further comprises a first chock adjustor fixedly connected to the first wheel chock and a second chock adjustor fixedly connected to the second wheel chock, and wherein the first and second chock adjustors are threadedly engaged with the oppositely threaded portions of the tensioner adjuster.
